(19) United States
(12) Patent Application Publication
(10) Pub. No.: US 2024/0426330 A1
(43) Pub. Date: Dec. 26, 2024

(54) PUNCH-RIVETED CONNECTION

(71) Applicant: AUDI AG, Ingolstadt (DE)

(72) Inventors: Jan-Oliver BRASSEL, Bad Friedrichshall (DE); Jörg SPINDLER, Überlingen (DE); Jochen RINTELMANN, Dessau (DE)

(73) Assignee: AUDI AG, Ingolstadt (DE)

(21) Appl. No.: 18/262,607

(22) PCT Filed: Feb. 7, 2022
(86) PCT No.: PCT/EP2022/052819

§ 371 Date: Jul. 24, 2023

(30) Foreign Application Priority Data
Mar. 29, 2021 (DE) 10 2021 107 789.3

(51) Int. Cl. F16B 5/04

(52) U.S. Cl. CPC F16B 5/04

(57) ABSTRACT

A punch rivet connection having at least two joining partners, which are connectable to one another in a setting process, in which a semi-tubular punch rivet is drivable in a setting direction with its rivet foot through the setting-side joining partner into the die-side joining partner, while maintaining a residual base thickness in the die-side joining partner and with spreading of the rivet foot, so that the joining partner, viewed in the setting direction, is clamped under compressive stress between a rivet head and a rivet foot cutting edge of the semi-tubular punch rivet. The setting-side joining partner includes a pilot hole through which the semi-tubular punch rivet is drivable into the die-side joining partner, so that in the setting-side joining partner a build-up of shear stress transverse to the setting direction is reduced or eliminated.

### FIELD

The invention relates to a punch rivet connection, a semi-tubular punch rivet for such a punch rivet connection, and a method.

### BACKGROUND

A punch rivet connection of this type includes at least two joining partners, which are connected to one another in a setting process. In the setting process, a semi-tubular punch rivet is driven in a setting direction with its rivet foot through the setting-side joining partner into the die-side joining partner. This takes place while maintaining a residual base thickness in the die-side joining partner and with spreading of the rivet foot. This results in an undercut between a rivet foot cutting edge and the rivet head of the semi-tubular punch rivet, between which the joining partners are clamped. Such a punch rivet connection is used in particular for mixed construction connections (for example aluminium-steel mixed construction).

An aluminum die-cast part is problematic as a joining partner in such a punch rivet connection insofar as it is susceptible to shear stresses aligned transversely to the setting direction, which are generated during the setting process when the semi-tubular punch rivet is driven into the joining partner. Such shear stresses can result in stress cracks in the aluminum die-cast part, which can result in premature component failure.

A forming method and a device for carrying out the method are known from DE 10 2011 054 358 A1. A punch rivet and a punch riveting method are known from DE 10 2013 020 504 A1. A semi-tubular punch rivet for a punch rivet connection is known from DE 10 2019 102 383 A1. A method for producing a connection between a functional element and a plate-shaped component is known from DE 10 2015 014 941 A1. A rivet that can be used as a decorative rivet and/or connecting rivet is known from DE 203 03 961 U1.

### SUMMARY

The object of the invention is to provide a punch rivet connection, the functionality of which is increased in a simple manner compared to the prior art and in particular is also usable as a joining partner with aluminum die-cast parts.

The invention relates to a punch rivet connection having at least two joining partners, which are connectable to one another in a setting process. In the setting process, a semi-tubular punch rivet is driven in a setting direction with its rivet foot through the setting-side joining partner into the die-side joining partner. This takes place while maintaining a residual base thickness in the die-side joining partner and with expansion of the rivet foot. According to the characterizing part of claim 1, the setting-side joining partner includes a pilot hole in the still non-deformed state. The semi-tubular punch rivet is guided through the pilot hole essentially without any stress and is driven into the die-side joining partner, which in the non-deformed state has no pilot hole. In this way, the setting-side joining partner, viewed in the setting direction, is clamped under compressive stress between the rivet head of the semi-tubular punch rivet and the rivet foot cutting edge. By providing the pilot hole, a build-up of shear stress transverse to the setting direction can preferably be reduced or completely eliminated in comparison to the prior art. In this way, the field of application of the punch rivet connection is also extended to joining partners that are susceptible to shear stresses aligned transversely to the setting direction, such as an aluminum die-cast part.

In a technical implementation, a hole play can be formed between a pilot hole inner wall de-limiting the hole path of the pilot hole and the rivet foot, by means of which component stresses between the joining partners can be compensated. For the case that the joining partners have different coefficients of thermal expansion, the different thermal expansions of the joining partners when exposed to heat can be compensated for by using up the hole play without shear stress building up in the setting-side joining partner.

The hole path of the pilot hole formed in the setting-side joining partner can, viewed in the setting direction, taper conically, specifically between a small-diameter hole section and a large-diameter hole section of the pilot hole. In this case, the small-diameter hole section is dimensioned larger by the hole play than the diameter of the rivet foot of the semi-tubular punch rivet in order to ensure a substantial freedom from shear stress in the setting-side joining partner. In a manner preferred in manufacturing, the small-diameter hole section of the pilot hole can be formed on the contact side of the setting-side joining partner with the die-side joining partner. In this case, the pilot hole widens conically counter to the setting direction. During the setting stroke, the conical surface of the pilot hole can form an intake slope, along which the semi-tubular punch rivet is guided load-free in the direction of the die-side joining partner.

The large-diameter hole section of the conically tapering hole passage of the pilot hole is preferably dimensioned smaller than the head diameter of the rivet head. This ensures that the under-side of the rivet head acts as a height stop during the setting process, which interacts with the surface of the setting-side joining partner facing toward it. In addition, it is ensured that the larger-diameter rivet head completely covers the pilot hole formed in the setting-side joining partner.

In a technical implementation, the rivet foot can include a cylindrical rivet foot wall, which delimits a bolt indentation radially on the inside, which is open at the rivet foot cutting edge. During the setting process, the bolt indentation is filled with the joining partner material, due to which the rivet foot cutting edge spreads radially outward transverse to the setting direction. The bolt indentation can extend along the bolt axis over a height between the rivet foot cutting edge and the apex. The height of the bolt indentation is designed with regard to a perfect spreading behavior of the semi-tubular punch rivet. The apex of the bolt indentation can preferably act as a stop against which a material slug of a joining partner presses during the setting process, specifically with the build-up of a spreading force that supports the spreading of the rivet foot.

Viewed in the axial direction, a material thickening can be formed between the apex of the bolt indentation and an underside of the rivet head. The material thickening extends over an axial length between the apex and the underside of the rivet head. Depending on the axial length of the material thickening, the spreading behavior of the rivet foot can be adjusted during the setting process. In particular, with the aid of the material thickening, a spreading movement of the rivet foot in the pilot hole of the setting-side joining partner can be reduced or prevented, due to which a build-up of shear stress transverse to the setting direction in the setting-side joining partner is avoidable. In a preferred embodiment variant, the axial length of the material thickening can correspond to the material thickness of the setting-side joining partner.

In a first embodiment variant, the material thickening can be implemented as a solid material section over its entire axial length. Alternatively thereto, the material thickening can have an internal hollow profile, which is implemented with a smaller diameter in comparison to the bolt indentation. In this case, the large-diameter bolt indentation merges along the bolt axis at an annular shoulder into the small-diameter internal hollow profile. In the non-deformed state, the inner hollow profile can be offset by a material offset from the underside of the rivet head, viewed in the axial direction. By means of the material offset, the rivet head is designed to be a sufficiently rigid component to ensure a perfect transfer of force to the rivet foot in the setting process.

In a particularly preferred embodiment, the setting-side joining partner can be an aluminum die-cast part in which the pilot hole is not formed by mechanical machining, but rather by primary shaping, i.e., during the injection molding process. In this case, the pilot hole inner wall can taper to form a demolding slope, so that perfect demolding is ensured after the injection molding process. The formation of the pilot hole by primary shaping significantly increases the notched impact strength of the setting-side joining partner, compared to mechanical machining, which further reduces premature component failure of the setting-side joining partner.

### BRIEF DESCRIPTION OF THE FIGURES

Exemplary embodiments of the invention are described hereinafter on the basis of the appended figures.

In the figures:

FIG. 1 shows a micrograph of a punch rivet connection according to a first exemplary embodiment;

FIG. 2 shows a view, based on which a process step for producing the punch rivet connection is illustrated;

FIG. 3 shows a view, based on which a process step for producing the punch rivet connection is illustrated;

FIG. 4 shows a view, based on which a process step for producing the punch rivet connection is illustrated;

FIG. 5 shows an exemplary embodiment of the invention.

FIG. 6 shows an exemplary embodiment of the invention.

FIG. 7 shows an exemplary embodiment of the invention.

FIG. 8 shows an exemplary embodiment of the invention.

### DETAILED DESCRIPTION

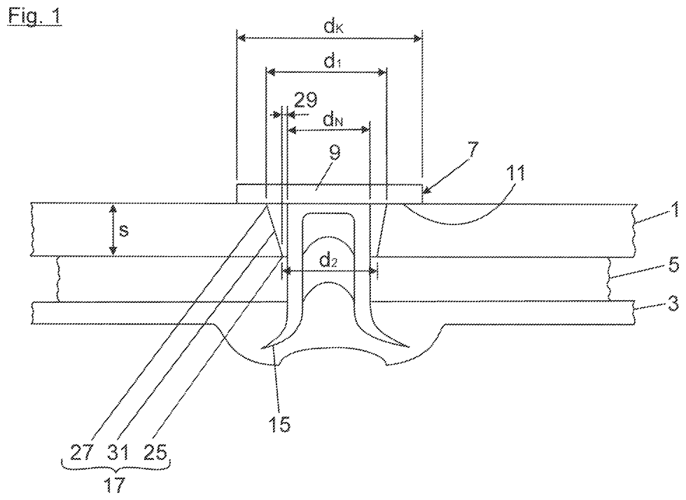

FIG. 1 shows a punch rivet connection having a setting-side joining partner 1, a die-side joining partner 3, and an interposed joining partner 5. The punch rivet connection is produced in a setting process indicated with reference to FIG. 4 with the aid of a semi-tubular punch rivet 7, which has a large-diameter rivet head 9, which is implemented as a flat head. On its rivet head underside 11, the rivet head 9 merges into a small-diameter rivet foot 13, which terminates at a circumferential rivet foot cutting edge 15. The semi-tubular punch rivet 7 is implemented in the non-deformed state as a component that is rotationally symmetrical around a bolt axis B.

In the punch rivet connection shown in FIG. 1, the semi-tubular punch rivet 7 is driven through the setting-side joining partner 1 and through the middle joining partner 5 into the die-side joining partner 3, while maintaining a residual base thickness in the die-side joining partner 3. According to FIG. 1, the rivet foot 13 is spread out, resulting in an undercut between the rivet foot cutting edge 15 and the underside 11 of the rivet head. The three joining partners 1, 3, 5 are therefore clamped together under compressive stress acting in the setting direction.

In FIG. 1, a mixed construction connection is implemented by way of example, in which the setting-side joining partner 1 is an aluminum die-cast part, while the die-side joining partner 3 can be a steel sheet and the interposed joining partner 5 can be an aluminum sheet.

The essence of the invention is that by providing a pilot hole 17, a build-up of shear stress transverse to the setting direction in the setting-side joining partner 1 is reduced or completely eliminated. In this way, premature component failure can be prevented in the setting-side joining partner 1, which is manufactured as an aluminum die-cast part.

In the setting process (FIG. 4), the semi-tubular punch rivet 7 is guided load-free through the pilot hole 17 of the setting-side joining partner 1 and is subsequently driven into the interposed joining partner 5 and the die-side joining partner 3, both of which are provided without a pilot hole.

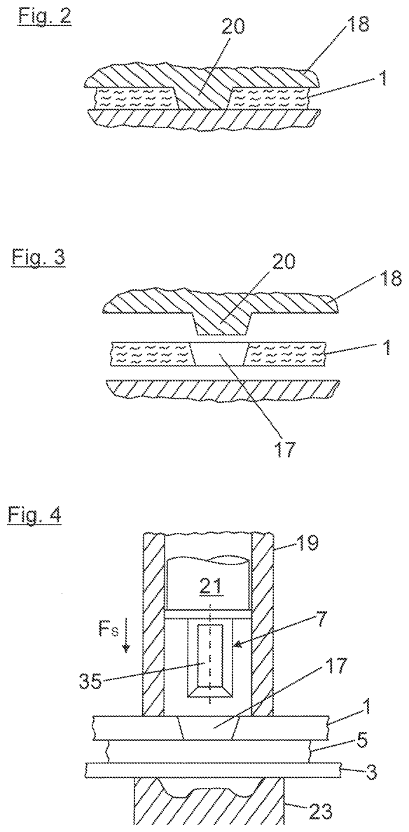

A method for producing the punch rivet connection shown in FIG. 1 is described below with reference to FIGS. 2 to 4: According to FIGS. 2 and 3, the setting-side joining partner 1 is produced in an injection molding process by primary shaping. FIG. 2 shows a process point in time after the injection molding process has taken place. Accordingly, the mold cavity of the injection mold 18 is still closed. According to FIGS. 2 and 3, the pilot hole 17 is formed by means of a shaped projection 20 formed on the upper injection mold half. In FIGS. 2 and 3, the mold projection 20 is designed with a conical demolding slope in order to ensure perfect demolding after the injection molding process. Accordingly, the pilot hole 17 formed in the setting-side joining partner 1 widens upwards.

In the setting process indicated in FIG. 4, a three-layer structure consisting of the three joining partners 1, 3, 5 is clamped between a hold-down device 19 and a die 21. A setting punch 21 is guided in a stroke-adjustable manner within the hold-down device 19. In the setting process, the setting punch 21 applies a setting force F_{S} to the rivet head 9, as a result of which the semi-tubular punch rivet 7 pierces the interposed joining partner 5 and is driven into the die-side joining partner 3 with its rivet foot cutting edge 15. The setting-side joining partner 1 remains unloaded during the setting process and is only subjected to compressive stress, which acts in the setting direction, after the setting process has taken place.

In FIG. 4, the small-diameter hole section 25 (FIG. 1) of the pilot hole 17 is positioned on the contact side of the setting-side joining partner 1 with the die-side joining partner 3. The small-diameter hole section 25 of the pilot hole 17 has a diameter d₂ (FIG. 1) which is larger by a hole play 29 than the rivet foot diameter d_{N} (FIG. 1).

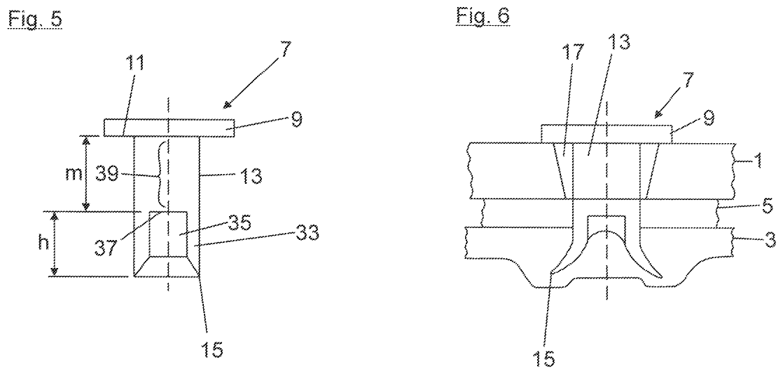

The rivet foot 13 of the semi-tubular punch rivet 7 has a cylindrical rivet foot wall 33 (FIG. 5) which delimits a bolt indentation 35 radially on the inside. The bolt indentation 35 is open at the rivet foot cutting edge 15 and extends along the bolt axis B over a height h between the rivet foot cutting edge 15 and an inner apex 37.

In order to avoid shear stresses occurring in the setting-side joining partner 1 during the setting process, the semi-tubular punch rivet 7 can be adapted according to FIGS. 5 to 8: As a result, the semi-tubular punch rivet 7 in FIG. 5 includes a material thickening 39, which extends over an axial length m, between the apex 37 of the bolt indentation 35 and the underside 11 of the rivet head. By means of the material thickening 39, a spreading movement of the rivet foot 13 in the pilot hole 17 of the setting-side joining partner 1 is reduced in the setting process in order to avoid or reduce the build-up of shear stress.

In FIGS. 5 and 6, the material thickening 39 is implemented as a solid material section over its entire axial length m.

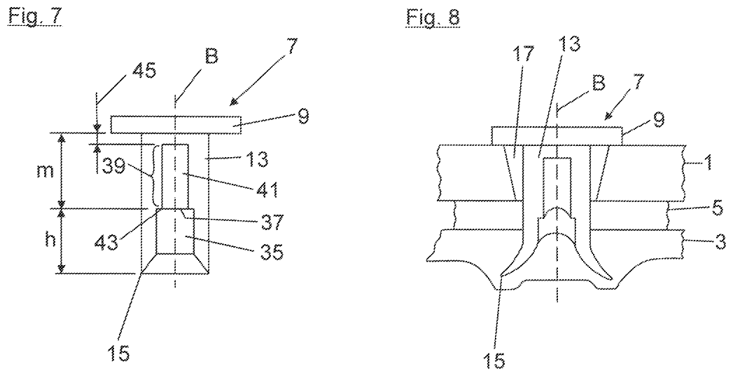

In contrast to this, in the exemplary embodiment of FIGS. 7 and 8, the material thickening 39 is not implemented as a solid material, but rather the material thickening 39 has an inner hollow profile 41, which has a smaller diameter than the bolt indentation 35. According to FIGS. 7 and 8, the semi-tubular punch rivet 7 therefore has an inner bore consisting of the large-diameter bolt indentation 35 which merges into the small-diameter inner hollow profile 41 at an annular shoulder 43.

In order to ensure sufficient rivet component rigidity in the setting process, in FIG. 7 the inner hollow profile 41 is offset by a material offset 45 from the underside 11 of the rivet head, viewed in the axial direction.

### LIST OF REFERENCE SIGNS

1 setting-side joining partner
3 die-side joining partner
5 interposed joining partner
7 semi-tubular punch rivet
9 rivet head
11 underside of rivet head
13 rivet foot
15 rivet foot cutting edge
17 pilot hole
18 injection mold
19 hold-down device
20 mold projection
21 setting punch
23 die
25 small-diameter hole section
27 large-diameter hole section
29 displacement space
31 pilot hole inner wall
33 rivet foot wall
35 bolt indentation
37 apex
39 material thickening
41 inner hollow profile
43 annular shoulder
45 material offset
B bolt axis
m axial length of the material thickening
h height of the bolt indentation
S material thickness of the setting-side joining partner
F_{S} setting force
d_{N} rivet foot diameter
d_{K} rivet head diameter
d₁ diameter of the large-diameter hole section
d₂ diameter of the small-diameter hole section

1-10. (canceled)

11. A punch rivet connection having at least two joining partners, which are connectable to one another in a setting process, in which a semi-tubular punch rivet is drivable in a setting direction with its rivet foot through the setting-side joining partner into the die-side joining partner, while maintaining a residual base thickness in the die-side joining partner and with spreading of the rivet foot, so that the joining partners, viewed in the setting direction, are clamped under compressive stress between a rivet head and a rivet foot cutting edge of the semi-tubular punch rivet, wherein the setting-side joining partner includes a pilot hole through which the semi-tubular punch rivet is drivable into the die-side joining partner, so that in the set-ting-side joining partner a build-up of shear stress transverse to the setting direction is reduced or eliminated.

12. The punch rivet connection as claimed in claim 11, wherein the joining partners have different coefficients of thermal expansion, so that the joining partners are subject to different thermal expansions when exposed to heat, and/or in that in particular the rivet foot is guided with hole play through the pilot hole of the set-ting-side joining partner, and in that the different thermal expansions can be compensated by using up the hole play, particularly when exposed to heat, without shear stress building up transversely to the direction of setting in the joining partner on the setting side.

13. The punch rivet connection as claimed in claim 12, wherein the hole path of the pilot hole tapers at least partially conically in the setting direction, specifically between a small-diameter hole section and a large-diameter hole section, and/or in that in particular the diameter of the small-diameter hole section is dimensioned larger by the hole play than the diameter of the rivet foot, and/or in that in particular the small-diameter hole section of the pilot hole is formed on the contact side of the setting-side joining partner with the die-side joining partner, and/or in that in particular the pilot hole widens conically counter to the setting direction, and/or in that the head diameter of the rivet head is dimensioned larger than the diameter of the large-diameter hole section of the pilot hole.

14. The punch rivet connection as claimed in claim 11, wherein the rivet foot has a cylindrical rivet foot wall which delimits a bolt indentation radially on the inside, which is open at the rivet foot cutting edge, and in that in particular the bolt in-dentation extends along the bolt axis over a height between the rivet foot cutting edge and the apex.

15. The punch rivet connection as claimed in claim 14, wherein, viewed in the axial direction between the apex of the bolt indentation and an underside of the rivet head, a material thickening is formed, which extends over an axial length, and in that in particular by means of the material thickening, a spreading movement of the rivet foot in the pilot hole of the setting-side joining partner can be reduced or pre-vented in the setting process.

16. The punch rivet connection as claimed in claim 15, wherein the material thickening is implemented over its entire axial length as a solid material section.

17. The punch rivet connection as claimed in claim 15, wherein the material thickening has an inner hollow profile with a small diameter compared to the bolt indentation, and in that, in particular when viewed in the axial direction, the large-diameter bolt indentation merges at an annular shoulder into the small-diameter inner hollow profile, and in that in particular the inner hollow profile, viewed in the axial direction, is offset by a material offset from the underside of the rivet head.

18. The punch rivet connection as claimed in claim 11, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.

19. A semi-tubular punch rivet for a punch rivet connection as claimed in claim 11.

20. A method for producing a punch rivet connection as claimed in claim 11.

21. The punch rivet connection as claimed in claim 12, wherein the rivet foot has a cylindrical rivet foot wall which delimits a bolt indentation radially on the inside, which is open at the rivet foot cutting edge, and in that in particular the bolt indentation extends along the bolt axis over a height between the rivet foot cutting edge and the apex.

22. The punch rivet connection as claimed in claim 13, wherein the rivet foot has a cylindrical rivet foot wall which delimits a bolt indentation radially on the inside, which is open at the rivet foot cutting edge, and in that in particular the bolt indentation extends along the bolt axis over a height between the rivet foot cutting edge and the apex.

23. The punch rivet connection as claimed in claim 12, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.

24. The punch rivet connection as claimed in claim 13, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.

25. The punch rivet connection as claimed in claim 14, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.

26. The punch rivet connection as claimed in claim 15, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.

27. The punch rivet connection as claimed in claim 16, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.

28. The punch rivet connection as claimed in claim 17, wherein the setting-side joining partner is an aluminum die-cast part and/or in that the pilot hole is not produced by machining but by primary shaping, for example in an injection molding process, and in particular the conical pilot hole inner wall forms a demolding slope in order to ensure perfect demolding after the injection molding process.
